(19) United States
(12) Patent Application Publication
(10) Pub. No.: US 2023/0223605 A1
(43) Pub. Date: Jul. 13, 2023

(54) BATTERY CELL CONTACTING DEVICE, AND BATTERY MODULE CONTAINING SUCH A BATTERY CELL CONTACTING DEVICE

(71) Applicant: Diehl AKO Stiftung & Co. KG, Wangen (DE)

(72) Inventors: Arkadiusz Dutka, Nürnberg (DE); Mateusz Kurpiel, Wangen (DE)

(21) Appl. No.: 18/180,312

(22) Filed: Mar. 8, 2023

Related U.S. Application Data
(63) Continuation of application No. PCT/EP2021/077271, filed on Oct. 4, 2021.

(30) Foreign Application Priority Data
Nov. 3, 2020 (DE) 10 2020 128 195.4
Feb. 12, 2021 (DE) 10 2021 103 388.8

(51) Int. Cl. H01M 10/42; H01R 11/28; H01M 50/209; H01M 50/284; H01M 50/298; H01M 50/516; H01M 10/48

(52) U.S. Cl. CPC H01M 10/425; H01R 11/288; H01M 50/209; H01M 50/284; H01M 50/298; H01M 50/516; H01M 10/486; H01M 2010/4271

(57) ABSTRACT

A battery cell contacting device for a battery module having a plurality of battery cells electrically coupled to one another via a plurality of cell connectors has a rigid printed circuit board, which, in the region next to the plurality of cell connectors, is arranged over the battery cells and is connected to the plurality of cell connectors via a plurality of contact elements. For the purpose of making fitting easier and more reliable, each of the plurality of contact elements is formed from an electrically conductive wire. The wire, at the first end section of the contact element, is electrically conductively connected to the printed circuit board and, at the opposite, second end section of the contact element, can be electrically conductively connected to the respective cell connector and/or is coupled to a sensor element which can be brought into contact with the respective cell connector.

### CROSS-REFERENCE TO RELATED APPLICATION

This application is a continuation, under 35 U.S.C. § 120, of copending International Patent Application PCT/EP2021/077271, filed Oct. 4, 2021, which designated the United States; this application also claims the priority, under 35 U.S.C. § 119, of German Patent Application DE 102020128915.4, filed Nov. 3, 2020, and DE 102021103388.8, filed Feb. 12, 2021; the prior applications are herewith incorporated by reference in their entirety.

### FIELD AND BACKGROUND OF THE INVENTION

The present invention relates to a battery cell contacting device for a battery module having a plurality of battery cells and/or battery cell groups electrically coupled to one another via a plurality of cell connectors and a battery module having such a battery cell contacting device.

Cell management controllers (CMC) which monitor the individual battery cells of the battery module in order to perform, for example, charging processes, balancing of the voltages and the states of charge, temperature adjustment processes, etc. for the battery cells require a battery cell contacting device for contacting the battery cells and/or the cell connectors in order to obtain corresponding measurement signals, for example, of the potentials and the temperatures of the battery cells. Conventional battery cell contacting devices involve a high degree of manufacturing-related and fitting-related complexity for the linking of the signal sources to the signal line system. In addition, there is often the risk in conventional battery cell contacting devices that the contacting of the battery cells or cell connectors is destroyed in the case of movements or swelling of the battery cells.

### SUMMARY OF THE INVENTION

The object of the present invention consists in providing an improved battery cell contacting device having a simple design and simple and permanently reliable fitting.

This object is achieved by a battery cell contacting device having the features of the independent claim. Particularly advantageous configurations and developments of the invention are the subject matter of the dependent claims.

The battery cell contacting device of the invention is configured for a battery module having a plurality of battery cells and/or battery cell groups electrically coupled to one another via a plurality of cell connectors so that they are connected in series and/or parallel, depending on the arrangement and orientation of the battery cells. The battery cell contacting device has a printed circuit board, which, in the region next to the plurality of cell connectors, can be arranged over the battery cells/battery cell groups and can be connected to the plurality of cell connectors via a plurality of contact elements. Each of the plurality of contact elements has a first end section in the direction towards the printed circuit board and a second end section, which is opposite the first end section, in the direction towards a respective one of the plurality of cell connectors. In accordance with the present invention, it is proposed that each of the plurality of contact elements is formed from an electrically conductive wire which (i) runs between the first and the second end sections of the contact element, (ii) at the first end section of the contact element, is electrically conductively connected to the printed circuit board and (iii) at the second end section of the contact element, can be electrically conductively connected to the respective cell connector and/or is coupled to a sensor element which can be brought into contact with the respective cell connector. The plurality of cell connectors electrically coupling the plurality of battery cells and/or battery cell groups to one another can also be referred to as a busbar or busbar system. The feature that a contact element is formed from a wire is intended to mean in this context that the contact element not only contains a wire somewhere but substantially consists of a wire.

The use of electrically conductive wires for the contact elements has several advantages. Wires are standard component parts which have a simple structure, which can be configured variably and can be matched to specific application cases, and which enable simple electrical contact connections (for example by means of soldering or welding) to the printed circuit board (and therefore to signal lines of the printed circuit board) and to the cell connectors without additional special elements, which electrical contact connections can also take place in automated fashion. This enables simple and cost-effective fitting of the battery cell contacting device in a battery module. In addition, the flexibility of these contact elements can compensate for movements and swelling of the battery cells which can occur, for example, during charging and discharge cycles, which is not possible with rigid contact systems. The wires can also be coupled in a simple manner to sensor elements which detect properties of the battery cells and/or the cell connectors (for example temperature sensors). The flexibility of the wire contact elements advantageously also enables the use of a rigid printed circuit board, which enables simpler handling during manufacture and fitting and also the mounting of component parts such as, for example, electronic circuit elements thereon. The shape and the size of the rigid printed circuit board can in principle be matched to any desired constructions of battery modules, in particular to any desired arrangements, sizes and number of battery cells. Likewise, the number, the lengths, the orientations and the positions of the wire contact elements can in principle be matched to any desired constructions of battery modules, in particular to any desired arrangements, shapes and numbers of cell connectors for the battery cells.

The wires of the plurality of contact elements can preferably each be electrically conductively connected to the printed circuit board at the first end section of the contact element in at least one plated-through hole through the printed circuit board or at at least one contact panel on a surface of the printed circuit board. In the case of the plated-through holes, the wires can in principle be inserted into the plated-through hole from any desired side of the printed circuit board. In the case of the contact panels, these are preferably located on the upper side of the printed circuit board which is remote from the battery cells/battery cell groups. The contacting of the wires at the plated-through holes or contact panels can preferably take place by means of soldering, which can also take place in automated fashion.

In addition, the wires of the plurality of contact elements are preferably each configured to be able to be welded to a surface of the respective cell connector at the second end section of the contact element. The contacting of the wires at the cell connectors can preferably take place by means of an ultrasound welding method, which requires little time and can take place in automated fashion.

If the wire is coupled to a sensor element, this coupling can take place, for example, by means of soldering, and the sensor element is preferably configured to be able to be connected to the surface of the respective cell connector. Depending on the type of sensor element, the connection to the cell connector can take place by means of, for example, adhesive bonding, soldering or welding.

In one embodiment of the invention, the wire of a contact element runs in single-phase fashion between the first and the second end sections of the contact element. Wherein one end of the wire is electrically conductively connected to the printed circuit board at the first end section of the contact element, and the other end of the wire can be electrically conductively connected to the respective cell connector at the second end section of the contact element. The single-phase course of the wire means a single connecting line or, for example, an I shape of the contact element.

In another embodiment of the invention, the wire of a contact element runs in polyphase fashion between the first and the second end sections of the contact element. Wherein the ends of the wire are electrically conductively connected to the printed circuit board at the first end section of the contact element, and a bend (with a single curve, with a plurality of curves or a straight bend) in the wire can be electrically conductively connected to the respective cell connector at the second end section of the contact element. In yet another embodiment of the invention, the wire of a contact element runs in polyphase fashion between the first and the second end sections of the contact element, wherein a bend (with a single curve, with a plurality of curves or a straight bend) in the wire is electrically conductively connected to the printed circuit board at the first end section of the contact element, and the ends of the wire can be electrically conductively connected to the respective cell connector at the second end section of the contact element. The polyphase course of the wire means at least two connecting lines or, for example, a U shape or W shape of the contact element. The polyphase course of the wire has an additional advantage of a redundant connection and/or separate measurement and drive connections between the printed circuit board and the respective cell connector.

The plurality of contact elements of the battery cell contacting device can optionally be realized all in an identical or in different of the three abovementioned embodiments.

In one configuration of the invention, the battery cell contacting device furthermore has at least one signal management circuit, which is mounted on the printed circuit board or is connected to the printed circuit board. This signal management circuit is then for its part connected to a battery module controller or integrated therein. The battery module controller performs, for example, charging processes, balancing of the voltages and the states of charge, temperature adjustment processes, such as, in particular, cooling processes, and the like, at least partially depending on the measurement signals obtained by the battery cell contacting device. The battery cell contacting device, the signal management circuit and the battery module controller can also be referred to together as cell management controller (CMC).

In a further configuration of the invention, the printed circuit board of the battery cell contacting device can have at least one ventilation opening (for example in the form of a plurality of holes or a slit). Such ventilation openings can assist a cooling process of the battery cells beneath the rigid printed circuit board.

The subject matter of the invention is also a battery module having a plurality of battery cells and/or battery cell groups arranged next to one another and each having at least one positive electrode terminal and at least one negative electrode terminal. A plurality of cell connectors each electrically connect the electrode terminals of adjacent ones of the plurality of battery cells/battery cell groups to one another, Finally, an above-described battery cell contacting device of the invention is provided. Wherein, in the region next to the plurality of cell connectors, the printed circuit board is arranged over the battery cells/battery cell groups, and, at the second end section of the contact element, the electrically conductive wires of the plurality of contact elements are each electrically conductively connected to the respective cell connector and/or are coupled to a sensor element in contact with the respective cell connector. The wires of the plurality of contact elements are preferably each welded to the respective cell connectors at the second end section of the contact element by means of an ultrasound welding method.

The battery cells are connected to one another via cell connectors and are connectable to a consumer or a charging system via an electrical terminal of the battery module. The battery cells and the battery cell contacting device are preferably both accommodated in a module housing. The invention is not restricted to a specific number, size or arrangement of the plurality of battery cells/battery cell groups.

The invention is advantageously applicable for battery modules for vehicles, in particular electric vehicles and hybrid vehicles and in particular motor vehicles and motorcycles, and also for energy storage systems and other electrical appliances.

Other features which are considered as characteristic for the invention are set forth in the appended claims.

Although the invention is illustrated and described herein as embodied in a battery cell contacting device, and a battery module containing such a battery cell contacting device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A is a diagrammatic, plan view of a battery cell contacting device in accordance with a first exemplary embodiment of the invention used in a battery module;

FIG. 1B is a plan view of the battery cell contacting device in accordance with a second exemplary embodiment of the invention used in a battery module;

FIG. 2 is a perspective view of a possible arrangement of a plurality of battery cells beneath the battery cell contacting device shown in FIGS. 1A and 1B;

FIGS. 3 and 4 are partial, perspective views of the battery cell contacting device shown in FIGS. 1A and 1B;

FIGS. 5 to 8 are perspective detail views of in each case one contact element in accordance with various embodiments of the invention;

FIG. 9 is an illustration of a jumper wire for possible use for the contact elements;

FIG. 10 is a perspective detail view of the contact element having a sensor element in accordance with one embodiment of the invention; and

FIGS. 11 to 13 are perspective detail views of in each case one contact element in accordance with various further embodiments of the invention.

### DETAILED DESCRIPTION OF THE INVENTION

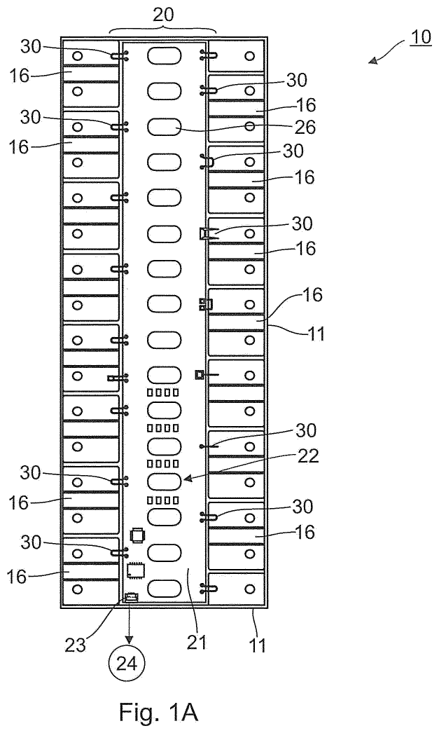

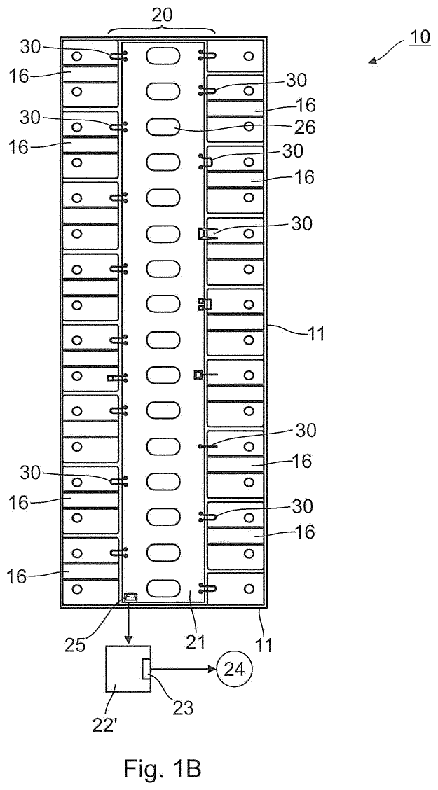

Referring now to the figures of the drawings in detail and first, particularly to FIGS. 1A-4 thereof, there is shown basic built-on accessories of a battery module 10 and a battery cell contacting device 20 according to the invention will now be explained in more detail by way of example.

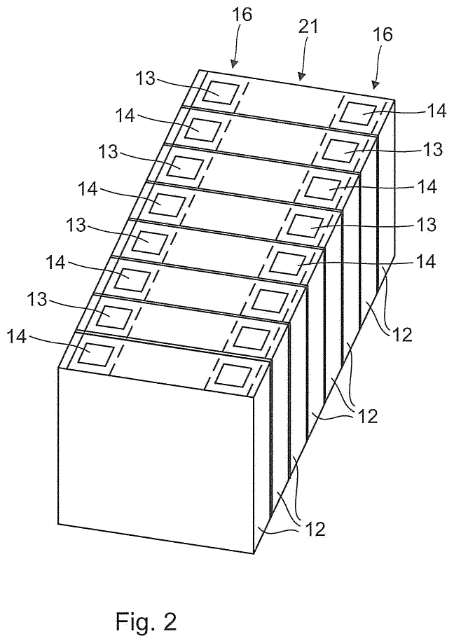

The battery module 10 has a multiplicity of battery cells 12 (optionally at least partially in the form of a plurality of battery cell groups) arranged in a module housing 11. In this exemplary embodiment, the battery cells are arranged next to one another in the right-to-left direction in FIGS. 1A and 1B and each have a positive electrode terminal 13 and a negative electrode terminal 14 in the upper end region. The positive and negative electrode terminals 13, 14 of the battery cells 12 are arranged alternately so that a positive electrode terminal 13 of a battery cell 12 is located next to a negative electrode terminal 14 of an adjacent battery cell 12, as is illustrated in FIG. 2.

As illustrated in FIGS. 1A and 1B, a multiplicity of cell connectors 16 is arranged on the battery cell arrangement, each of which cell connectors has two contact regions 16a, 16b and a (preferably elastic) compensation region 16c between the two contact regions 16a, 16b. The cell connectors 16 each couple, via their two contact regions 16a, 16b, the positive electrode terminal 13 of a battery cell 12 to the negative electrode terminal 14 of an adjacent battery cell 12 so that, in this exemplary embodiment, a series circuit of the battery cells 12 in the battery module 10 results. This systematics of a battery module 10 with battery cells 12 coupled electrically via cell connectors 16 is known in principle to a person skilled in the art, and the invention is not restricted to a specific construction thereof, for which reason it is possible to dispense with a more detailed illustration and description.

As illustrated in FIGS. 1A and 1B, the battery module 10 also contains a battery cell contacting device 20 which is arranged above the battery cells 12 and the cell connectors 16 in the module housing 11. The battery cell contacting device 20 consists substantially of a rigid printed circuit board 21, which can preferably be in the form of a multilayered printed circuit board. In these exemplary embodiments, the printed circuit board 21 has a substantially rectangular basic shape and is dimensioned such that it extends substantially over the entire length of the battery cell arrangement and fits between the two rows of cell connectors 16.

As indicated in FIGS. 1A and 1B, the printed circuit board 21 or its signal lines are electrically conductively connected to the cell connectors 16 via a multiplicity of contact elements 30. The contact elements 30 are provided on the two long side edges of the printed circuit board 21. The number of contact elements 30 corresponds to the number of cell connectors 16, and the contact elements 30 are each connected to a contact region 16a or 16b of a cell connector 16. Thus, the potentials of the electrode terminals 13, 14 of the battery cells 12 of the battery module 10 can be detected via the contact elements 30.

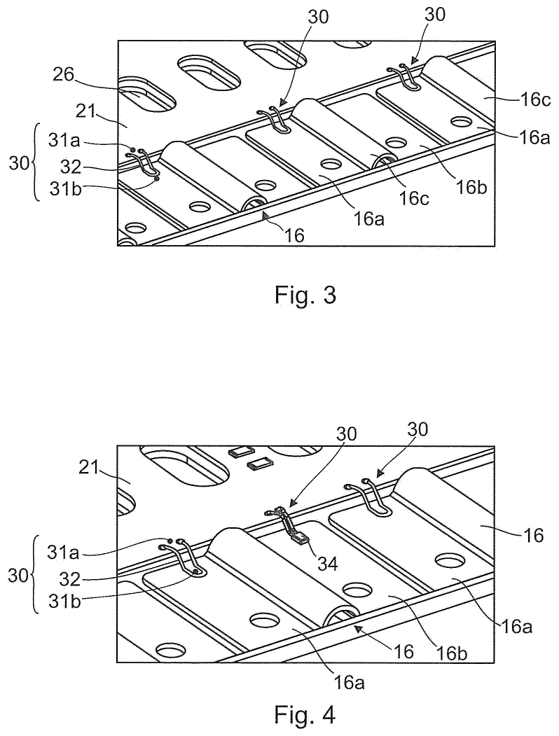

As illustrated in FIGS. 3 and 4, the contact elements 30 each have a first end section 31a in the direction towards the printed circuit board 21 and a second end section 31b, which is opposite the first end section 31a, in the direction towards a respective cell connector 16. The contact elements 30 each consist substantially of an electrically conductive wire 32, which runs between the two end sections 31a, 31b of the contact element 30. The electrically conductive wire 32 is preferably a metal wire. The wire 32 is electrically conductively connected to the printed circuit board 21 (more precisely to a signal line of the printed circuit board) at the first end section 31a of the contact element 30, and the wire 32 is electrically conductively connected to a contact region 16a or 16b of a respective cell connector 16 at the second end section 31b of the contact element 30. The connection of the wire 32 to the printed circuit board 21 takes place as early as during the production process of the printed circuit board 21, whereas the connection of the wire 32 to the cell connector 16 takes place once the printed circuit board 21 has been positioned onto the battery cell arrangement in the battery module 10.

The use of a wire for the contact element 30 naturally, i.e. without any further additional measures, generates an elasticity of the contact element, i.e. a possible movement of the second end section 31b relative to the first end section 31a on the rigid printed circuit board 21 both in a direction perpendicular to the plane of the rigid printed circuit board and in a plane parallel to the plane of the rigid printed circuit board. As a result, the contact elements 30 can compensate for both swellings and movements of the battery cells 12 in various orientations which can occur, for example, during charging and discharge cycles.

As illustrated in FIG. 4, the battery cell contacting device 20 can also have a pair of contact elements 30, in the case of which the wire 32 is coupled to a sensor element 34 (for example temperature sensor) at the second end section 31b. In this case, the sensor element 34 is in contact with a contact region 16b of the respective cell connector 16.

In the exemplary embodiment in FIG. 1A, an electronic signal management circuit 22 is additionally mounted on the printed circuit board 21, and the contact elements 30 are connected to said electronic signal management circuit via the signal lines (not illustrated) of the printed circuit board 21. The signal management circuit 22 is configured, for example, to perform the voltage measurement method and to evaluate the measurement signals obtained by the contact elements 30. As illustrated in FIG. 1A, the signal management circuit 22 can be connected to a battery module controller 24 via a connection interface 23. This battery module controller 24 serves to, for example, perform charging processes, balancing of the voltages and the states of charge, temperature adjustment processes such as, in particular, cooling processes, etc., wherein these processes are performed in a manner which is at least partially dependent on the measurement signals obtained by the battery cell contacting device 20 or measured values obtained by the signal management circuit 22 thereof.

The exemplary embodiment in FIG. 1B differs from that in FIG. 1A in that there is no signal management circuit 20 integrated in the printed circuit board 21, but rather a connection interface 25 to an external signal management circuit 22′ is provided on the printed circuit board 21. The external signal management circuit 22′ is likewise connected to a battery module controller 24 via a connection interface 23.

As illustrated in FIGS. 1A and 1B, the printed circuit board 21 in these exemplary embodiments has in each case a plurality of holes as ventilation openings 26 for assisting a cooling process of the battery cells 12 located underneath. As an alternative or in addition, the printed circuit board 21 can also have, as ventilation opening 26, at least one ventilation slit which extends over a large proportion of the length of the rigid printed circuit board. These ventilation openings 26 are used to assist a cooling process of the battery module 10.

In the text which follows, various specific embodiments of the contact elements 30 of the battery cell contacting device 20 will now be described in more detail by way of example.

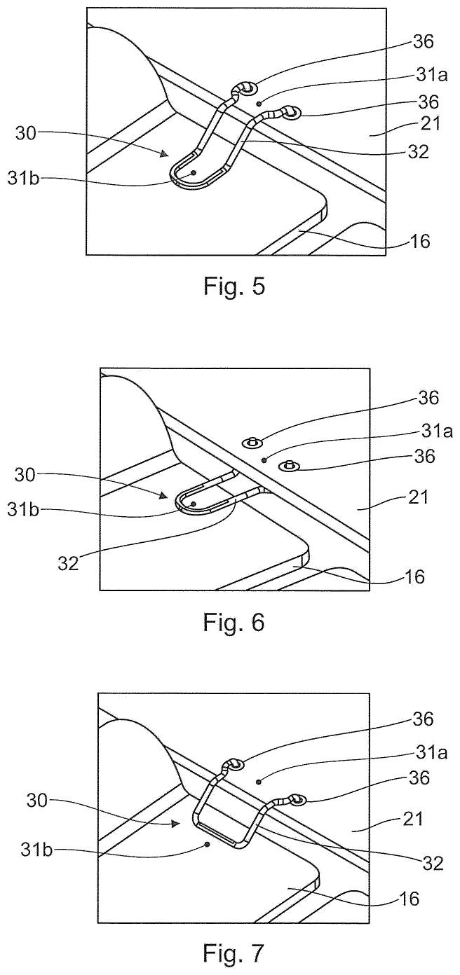

FIGS. 5 to 8 each show an embodiment in which the wire 32 is inserted into a plated-through hole 36 in the printed circuit board 21 at the first end section 31a of the contact element 30 and is electrically conductively connected to the printed circuit board 21 or the respective signal line in this plated-through hole 36, for example by means of soldering. At the second end section 31b of the contact element 30, the wire 32 is electrically conductively connected, for example welded (preferably by means of an ultrasound welding method), in each case to a surface of a contact region of the respective cell connector 16.

The wire 32 of the contact element 30 can optionally be inserted into the plated-through hole 36 on the upper side of the printed circuit board 21 which is remote from the battery cells 12 (see, for example, FIGS. 5, 7, 8) or can be inserted into the plated-through hole 36 on the lower side of the printed circuit board 21 which faces the battery cells 12 (see, for example, FIG. 6).

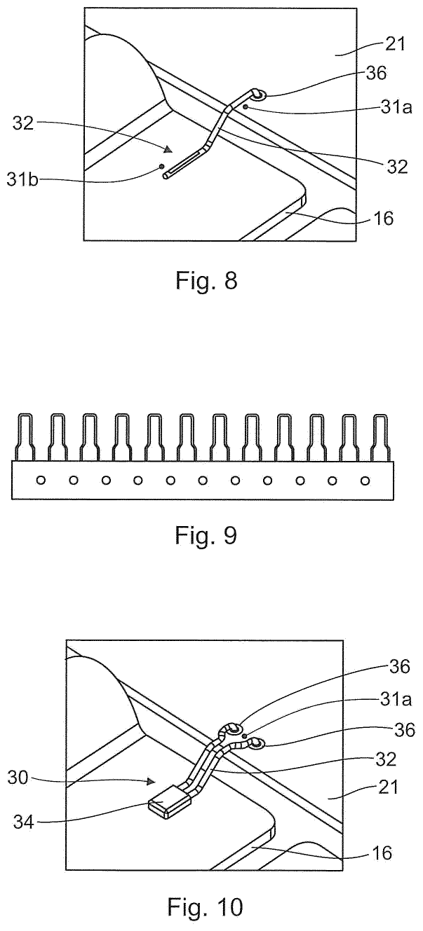

The wire 32 can run in single-phase fashion between the two end sections 31a, 31b of the contact element 30 (see, for example, FIG. 8), i.e. can have a substantially I shape with a single connecting line. In this case, one end of the wire 32 is inserted into a plated-through hole 36 in the printed circuit board 21 at the first end section 31a of the contact element 30 on the upper side of the printed circuit board 21 and soldered, and the other end of the wire 32 is welded to the respective cell connector 16 at the second end section 31b of the contact element 30. Optionally, the wire 32 can also, in the variant embodiment shown in FIG. 8, be inserted into the plated-through hole 36 at the first end section 31a on the lower side of the printed circuit board 21 which faces the battery cells 12.

Alternatively, the wire 32 can run in polyphase fashion between the two end sections 31a, 31b of the contact element 30 (see, for example, FIGS. 5, 6, 7), i.e. have, for example, a substantially U shape with two connecting lines. In this case, the two ends of the wire 32 are inserted into two plated-through holes 36 in the printed circuit board 21 at the first end section 31a of the contact element 30 and soldered, and the curved bend (FIGS. 5, 6) or the substantially straight bend (FIG. 7) in the wire 32 is welded to the respective cell connector 16 at the second end section 31b of the contact element 30. By virtue of this polyphase course, a redundant voltage measurement can be achieved via the contact element 30.

Preferably, a jumper wire can be used for the contact elements 30 illustrated in FIGS. 5 to 7, as is illustrated by way of example in FIG. 9.

FIG. 10 shows an embodiment in which the wire 32 which runs in polyphase fashion is inserted into plated-through holes 36 in the printed circuit board 21 at the first end section 31a of the contact element 30 and is electrically conductively connected to the printed circuit board 21 or the respective signal line in these plated-through holes 36, for example by means of soldering, and is coupled to a sensor element 34 (for example a temperature sensor) at the second end section 31b of the contact element 30. The sensor element 34 is brought into contact with the surface of the respective cell connector 16 (for example by means of adhesive bonding) in order to detect, for example, the temperature of the respective battery cell. Optionally, the wire 32 can also run, in the variant embodiment in FIG. 10, in single-phase fashion between the two end sections of the contact element 30 and/or can be inserted into the plated-through hole 36 at the first end section 31a on the lower side of the printed circuit board 21 which faces the battery cells 12.

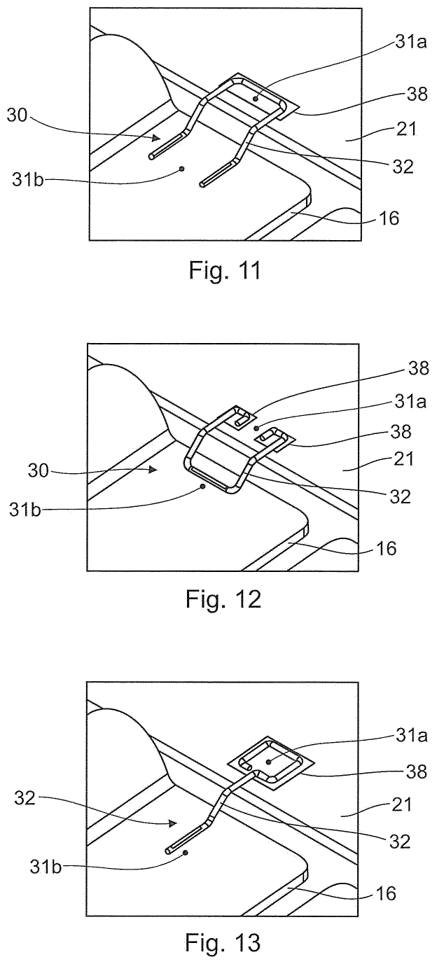

FIGS. 11 to 13 each show an embodiment in which the wire 32 is soldered to a contact panel 38 on a surface of the printed circuit board 21, instead of in at least one plated-through hole 36, at the first end section 31a of the contact element 30. At the second end section 31b of the contact element 30, this wire 32 is also electrically conductively connected, for example welded (preferably by means of an ultrasound welding method), in each case to a surface of a contact region of the respective cell connector 16. In the embodiments in FIGS. 11 to 13, the contact panel 38 to which the wire 32 is soldered is provided on the upper side of the printed circuit board 21; alternatively, it would also be possible to provide the contact panel 38 for soldering the wire 32 on the lower side of the printed circuit board 21.

In the embodiment in FIG. 11, the wire 32 runs in polyphase fashion between the two end sections 31a, 31b of the contact element 30, wherein the two ends of the wire 32 are welded to the respective cell connector 16 at the second end section 31b of the contact element 30, and the substantially straight bend (alternatively the curved bend) in the wire 32 is soldered to the contact panel 38 on the printed circuit board 21 at the first end section 31a of the contact element 30.

In the embodiment in FIG. 12, the wire 32 likewise runs in polyphase fashion between the two end sections 31a, 31b of the contact element 30. In this case, however, the two ends of the wire 32 are soldered to two contact panels 38 (alternatively to a common contact panel) on the printed circuit board 21 at the first end section 31b of the contact element 30, and the substantially straight bend (alternatively the curved bend) in the wire 32 is welded to the respective cell connector 16 at the second end section 31b of the contact element 30.

In the embodiment in FIG. 13, the wire 32 runs only in single-phase fashion between the two end sections 31a, 31b of the contact element 30, wherein one end of the wire 32 is soldered to a contact panel 38 on the printed circuit board 21 at the first end section 31b of the contact element 30, and the other end of the wire 32 is welded to the respective cell connector 16 at the second end section 31b of the contact element 30.

Within the scope of the invention defined in the attached claims, further embodiments of the contact elements 30 which include, for example, other feature variants and/or other combinations of features of the embodiments in FIGS. 5-8 and 10-13 are also conceivable. For example, the embodiments in FIGS. 11, 12, 13 can also be combined with a sensor element 34 in a similar manner to the embodiment in FIG. 10. For example, the wires which run in polyphase fashion in the embodiments in FIGS. 5-7 and 10-12 also include more than two connecting lines, for example approximately in a W shape.

The described battery modules 10 having the battery cell contacting devices 20 according to the invention can be used, for example, for vehicles, in particular electric vehicles and hybrid vehicles and in particular motor vehicles and motorcycles, or for energy storage systems or for other electrical appliances (for example electronic household appliances).

The following is a summary list of reference numerals and the corresponding structure used in the above description of the invention.

### LIST OF REFERENCE NUMERALS

10 battery module
11 module housing
12 battery cells
13 positive electrode terminals
14 negative electrode terminals
16 cell connectors
16a, 16b contact regions of the cell connectors
16c compensation regions of the cell connectors
20 battery cell contacting device
21 printed circuit board
22 signal management circuit
22′ external signal management circuit
23 connection interface to the battery module controller
24 battery module controller
25 connection interface to the external signal management circuit
26 ventilation openings
30 contact elements
31a first end section in the direction towards the printed circuit board
31b second end section in the direction towards the respective cell
connector
32 electrically conductive wire
34 sensor element
36 plated-through hole
38 contact panel

1. A battery cell contacting device for a battery module having a plurality of battery cells and/or battery cell groups electrically coupled to one another via a plurality of cell connectors, the battery cell contacting device comprising:
a plurality of contact elements;
a sensor;
a printed circuit board which, in a region next to the plurality of cell connectors, is disposed over the battery cells and/or the battery cell groups and is connected to the plurality of cell connectors via said plurality of contact elements;
wherein each of said plurality of contact elements has a first end section in a direction towards said printed circuit board and a second end section, being opposite said first end section, in a direction towards a respective one of the plurality of cell connectors; and
wherein each of said plurality of contact elements is formed from an electrically conductive wire, wherein said electrically conductive wire runs between said first and said second end sections of a respective one of said contact elements, wherein, at said first end section of said respective contact element, said electrically conductive wire is electrically conductively connected to said printed circuit board, and wherein, at said second end section of said respective contact element, said electrically conductive wire is electrically conductively connected to the respective cell connector and/or is coupled to said sensor which is brought into contact with the respective cell connector.

2. The battery cell contacting device according to claim 1, wherein:
said printed circuit board has a plurality of plated-through holes formed therein; and
said electrically conductive wire of each of said plurality of contact elements is electrically conductively connected to said printed circuit board at said first end section of said respective contact element in at least one of said plated-through holes through said printed circuit board.

3. The battery cell contacting device according to claim 1, wherein said electrically conductive wire of each of said plurality of contact elements is configured to be able to be welded to a surface of the respective cell connector at said second end section of said respective contact element.

4. The battery cell contacting device according to claim 1, wherein at least one said electrically conductive wire of said plurality of contact elements runs in single-phase fashion between said first and said second end sections of said respective contact element, wherein one end of said electrically conductive wire is electrically conductively connected to said printed circuit board at said first end section of said respective contact element, and another end of said electrically conductive wire is electrically conductively connected to the respective cell connector at said second end section of said respective contact element.

5. The battery cell contacting device according to claim 1, wherein at least one said electrically conductive wire of said plurality of contact elements runs in polyphase fashion between said first and said second end sections of said respective contact element, wherein ends of said electrically conductive wire are electrically conductively connected to said printed circuit board at said first end section of said respective contact element, and a bend in said electrically conductive wire is electrically conductively connected to the respective cell connector at said second end section of said respective contact element.

6. The battery cell contacting device according to claim 1, wherein at least one said electrically conductive wire of said plurality of contact elements runs in polyphase fashion between said first and said second end sections of said respective contact element, wherein a bend in said electrically conductive wire is electrically conductively connected to said printed circuit board at said first end section of said respective contact element, and ends of said electrically conductive wire are electrically conductively connected to the respective cell connector at said second end section of said respective contact element.

7. The battery cell contacting device according to claim 1, further comprising at least one signal management circuit mounted on said printed circuit board or is connected to said printed circuit board.

8. The battery cell contacting device according to claim 1, wherein said printed circuit board has at least one ventilation opening formed therein.

9. The battery cell contacting device according to claim 1,
further comprising at least one contact panel disposed on a surface of said printed circuit board;
wherein said printed circuit board has a plurality of plated-through holes formed therein; and
wherein said electrically conductive wire of each of said plurality of contact elements is electrically conductively connected to said printed circuit board at said first end section of said respective contact element in at least one of said plated-through holes through said printed circuit board or at said at least one contact panel.

10. A battery module, comprising:
a plurality of battery cells and/or battery cell groups disposed next to one another and each having electrode terminals including at least one positive electrode terminal and at least one negative electrode terminal;
a plurality of cell connectors each electrically connecting said electrode terminals of adjacent ones of said plurality of battery cells and/or said battery cell groups to one another; and
a battery cell contacting device according to claim 1, wherein, in said region next to said plurality of cell connectors, said printed circuit board is disposed over said battery cells and/or said battery cell groups, and, at said second end section of said respective contact element, said electrically conductive wire of each of said plurality of contact elements is electrically conductively connected to said respective cell connector and/or are coupled to said sensor in contact with said respective cell connector.

11. The battery module according to claim 10, wherein said electrically conductive wire of each of said plurality of contact elements is welded to said respective cell connectors at said second end section of said respective contact element by means of an ultrasound welding method.
